(19) United States
(12) Patent Application Publication
(10) Pub. No.: US 2004/0010436 A1
(43) Pub. Date: Jan. 15, 2004

(54) Method and apparatus providing an avenue for terminal service organizations to enlist customers for a web-service

(76) Inventor: Carol Fields, Berkeley, CA (US)

Correspondence Address: Earle Jennings, 8 Kenyon Ave, Kensington, CA, 94708, US

(21) Appl. No.: 10/607,708

(22) Filed: Jun. 27, 2003

Related U.S. Application Data
(63) Continuation-in-part of application No. 10/155,512, filed on May 24, 2002.

(51) Int. Cl. G06F 17/60

(52) U.S. Cl. 705/8

(57) ABSTRACT

The invention provides a method and a mechanism for a terminal service organization enlisting a customer for a web-service, including the following. The terminal service organization provides an avenue referring which the customer to the web-service. The customer uses the avenue to engage the web-service to provide at least one web-service product creating a web-site revenue for the web-service. The web-site product is customized by at least one instruction from the customer. And the terminal service organization receives an organization revenue based upon the customer using the avenue to create the web-site revenue.

The terminal service organization benefits by receiving the organization revenue from the use of the avenue by the customer. The customer benefits in being able to use the avenue to instruct the web-service to create the web-service products. These web-service products include at least one web-site component. Each web-site component is an instance of a web-site component collection.

### BACKGROUND OF THE INVENTION

1. Field of the Invention

The present invention relates to avenues by which terminal service organizations can enlist customers for a web-service. Terminal service organizations include any of the following: a funeral home, a retirement community, a hospice, a hospital, a sanitorium, a church, a shrine, a nursing home, a mausoleum, a cemetery, or an assisted living facility. A web-service provides web-service products based upon instructions from the customer.

2. Background Information

Today, there are numerous web-site service providers located all over the world. Several of these web-site service providers develop and host memorial web-sites for people based upon a customer request and the payment of a web-site service fee. There are even pet memorial web-site providers.

Every day, terminal service organizations aid the dying and those encountering the death of their loved ones. Yet these organizations are unprepared and disinclined to provide web-services to the dying as well as the bereaved mourning the dead.

The time of dying is a period of great stress and anguish for many. Communities struggle to express their loss. To remember, cherish, and honor those who have passed. Terminal service organizations do not support the potential of web-site products customized to present these cherished memories in an effective and interactive manner. The best they can provide is usually a piece of stone or metal and a few words, and occasionally, a picture embedded in the stone or metal.

Those approaching death often wish to leave recordings about their lives. Today, both terminal service organizations and web-site providers are ill equipped to provide recording equipment, trained interviewers and the editorial expertise needed to perfect those thoughts and words for the future.

There are also serious problems in the current relationship of terminal service organizations and web-site service providers, adversely affecting the bereaved. Terminal service organizations understand grief counseling, flowers, mortuary services, and other, very humanistic, services and products. They have little or no background in web-site development and management. Consequently, there are no direct avenues for the bereaved to order such services through terminal service organizations.

There is no economic incentive for terminal service organizations providing such avenues. By way of example, subscription fees for a typical web-site range between twenty to fifty US dollars, whereas a typical funeral costs several thousand dollars.

Today's memorial and personal web-sites tend to be open to everyone. This is naïve and dangerous from a financial security standpoint. Critical data, such as the maiden name of an individual's mother, are often present. Access to secured information, such as credit information and financial account privileges, often uses this critical data. Communities need secure mechanisms providing members access to personal and/or community web page systems.

To summarize, what is needed are avenues for terminal service organizations to enlist customers for web-services, which can provide web service products of a quality and timeliness worthy of the memory of those who pass from this life. The community members need to be able to access such web-service products, while protecting the financial security and privacy of the community.

### BRIEF SUMMARY OF THE INVENTION

The invention provides a method and a mechanism for a terminal service organization enlisting a customer for a web-service, including the following. The terminal service organization provides an avenue referring the customer to the web-service. The customer uses the avenue to engage the web-service to provide at least one web-service product creating a web-site revenue for the web-service. The web-site product is customized by at least one instruction from the customer. And the terminal service organization receives an organization revenue based upon the customer using the avenue to create the web-site revenue.

The terminal service organization benefits by receiving the organization revenue from the use of the avenue by the customer.

The customer benefits in being able to use the avenue to instruct the web-service to create the web-service products. These web-service products include at least one web-site component. Each web-site component is an instance of a web-site component collection.

The web-site component collection includes at least the following: an audio stream, a video stream, an interactive model, a text, a still frame, a web page layout, a security control, a hosting means, a transferring means, and an interactive means for generating at least one of the second web-site components.

The hosting means provides mechanisms for hosting at least one of the web-site components. Some of the hosting means provide a community with restricted access mechanisms, which protect the community from invasions to its privacy and potential theft of critical security information.

The transferring means provides a selection of delivery mechanisms for the web site products, supporting a range of delivery times and security options.

The interactive means may include providing the recording equipment, trained interviewers and editorial expertise needed to perfect the thoughts and words of the dying, and those remembering the dead, for the future.

The web-site component collection may further include a memorial web page system, a personal web page system, a family web page system, and a community web page system.

The invention includes making any or all of these systems available to the customers enlisted by the terminal service organizations through the web-service. The invention also includes the avenue provided to the customer, the customer instructions, the web-service products, the web-site revenue, and the organization revenue as products of the process of this invention.

### BRIEF DESCRIPTION OF THE DRAWINGS

FIG. 1A shows a business method and mechanism for a terminal service organization enlisting a customer for a web-service;

FIG. 1B shows a detail of the terminal service organization of FIG. 1A;

FIG. 2A shows a detail of the web-site component collection of FIG. 1A;

FIG. 2B shows the web-service product of FIG. 1A provided to a means for serving a community;

FIG. 2C shows a detail of the community of FIG. 2B;

FIG. 2D shows the means for serving the community of FIG. 2B including the web-service product used by at least one local computer system operated by at least one community member;

FIG. 2E shows the means for serving the community of FIG. 2B including web-site hosting the web-service product accessible only by the community members;

FIG. 2F shows the means for serving the community of FIG. 2B, including local means for hosting the web-service product accessible by the community members;

FIG. 3A shows the avenue of FIG. 1A including a computer system;

FIG. 3B shows a flowchart of the invention's method providing the avenue of FIGS. 1A and 3A;

FIG. 4A shows a detail of FIG. 3B identifying the customer;

FIG. 4B shows a detail of of FIG. 3B creating and sending the customer instruction of FIGS. 1A and 3A;

FIG. 5A shows an instruction collection for a web site component of the web-service product of FIG. 1C;

FIG. 5B shows the avenue of FIG. 1A at least partly implemented as a request form;

FIG. 5C shows the request media collection;

FIG. 5D shows several preferred embodiments identifying the terminal service organization when the request form is a paper request form;

FIG. 5E shows a bank account controlled by the terminal service organization receiving a monetary transfer of the organization revenue;

FIG. 5F shows the terminal service organization receiving a check for the organization revenue;

FIG. 6A shows details of the hosting means of FIG. 1D;

FIG. 6B shows the transfer means collection 720; and

FIG. 6C shows a preferred request form 400 of FIG. 5B.

### DESCRIPTION OF THE PREFERRED EMBODIMENTS

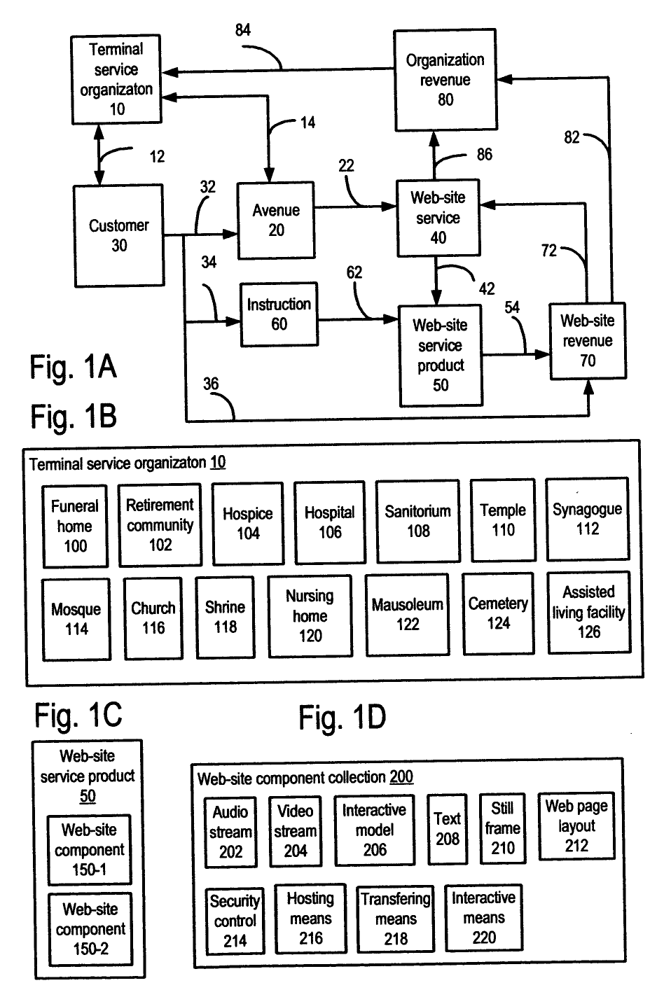

FIG. 1A shows a business method and mechanism for a terminal service organization 10 enlisting 12 a customer 30 for a web-service 40. The business method includes the following:

The terminal service organization 10 provides 12 an avenue 20 to the customer 30 referring 22 to the web-service 40. The avenue 20 identifies 14 the terminal service organization 10 to the web-service 40.

The customer 30 uses 32 the avenue 20 to engage 22 the web-service 40 to provide 42 at least one web-service product 50 to create 36 a web-site revenue 70 for 72 the web-service 40. The web-service product 50 is customized 62 by at least one instruction 60 from 34 the customer 30.

The terminal service organization 10 receives 84 an organization revenue 80 based upon 82 the web-site revenue 70 created by the customer 30 using 32 the avenue 20.

The invention includes the avenue 20 provided to the customer 30, the instruction 60, the web-service product 50, the web-site revenue 70, and the organization revenue 80, as products of the invention's process of doing business.

FIG. 1B shows the terminal service organization 10 of FIG. 1A including at least one of the following: a funeral home 100, a retirement community 102, a hospice 104, a hospital 106, a sanitarium 108, a temple 110, a synagogue 112, a mosque 114, a church 116, a shrine 118, a nursing home 120, a mausoleum 122, a cemetery 124, and an assisted living facility 126.

The web-service product 50 of FIG. 1A includes at least one web-site component 150-1, and often, preferably, at least a second web-site component 150-2, as shown in FIG. 1C.

The web-site component 150-1 of FIG. 1C is preferably an instance of a member of the web-site component collection 200 shown in FIG. 1D including, but not limited to, the following: an audio stream 202, a video stream 204, an interactive model 206, a text 208, a still frame 210, a web page layout 212, a security control 214, a hosting means 216 for at least one second web-site component 150-2, a transferring means 218 for at least one of the second web-site components 150-2, and an interactive means 220 for generating at least one of the second web-site components 150-2.

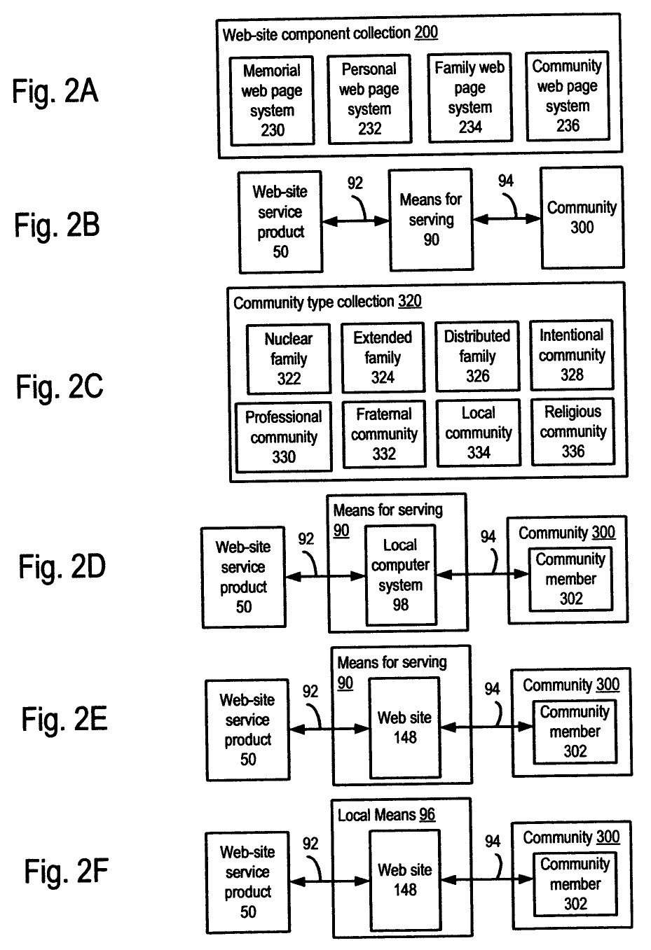

The web-service product 50 may provide a web-site for the customer 30, another individual, family, or community. FIG. 2A shows the web-site component collection 200 further including, but not limited to, the following: a memorial web page system 230, a personal web page system 232, a family web page system 234, and a community web page system 236.

The invention further includes the web-service product 50 provided 92 to a means 90 for serving 94 a community 300 as shown in FIG. 2B.

As used herein, the community 300 of FIG. 2B includes at least one instance of at least one member of the community type collection 320 shown in FIG. 2C comprising: a nuclear family 322, an extended family 324, a distributed family 326, an intentional community 328, a professional community 330, a fraternal community 332, a local community 334, and a religious community 336.

The nuclear family 322 of FIG. 2C includes at least two members, often living in close proximity to each other, usually linked by one or more social contracts and/or biological relationships.

As used herein, social contracts include, but are not limited to, acknowledgements of parenthood, child support agreements, marriage agreements, cohabitation agreements, parenting agreements, and/or adoption agreements. These agreements may be explicit or implicit, formal or informal. Specific governments and/or religions may or may not acknowledge such agreements. Irrespective of the acknowledgement of others, the members of these families base their actions upon these agreements.

As used herein, biological relationships inherently involve any combination of relationships including, but not limited to, parent to offspring, sibling to sibling, cousin to cousin, nephew/niece to aunt/uncle.

The extended family 324 of FIG. 2B includes members usually linked by one or more social contracts and/or biological relationships. Members of the extended family 324 often live at some distance from at least some of the other members.

The distributed family 326 of FIG. 2B includes a network of families linked by multiple layers of social contracts and/or biological relationships. These linked families may be nuclear and/or extended families.

The intentional community 328 of FIG. 2B includes at least two members intentionally creating the community. Intentional community can include cooperatives, which may collectively own and/or lease and/or manage one or more residences. These residences may include apartment buildings, and/or houses. The residences may have residential units for individuals and/or nuclear families. The members of the intentional community may share interests or views, which may include, but are not limited to, hobbies such as golfing, tennis and boating, residential appearance as evidenced in home owner association guidelines, life style, ecological, philosophical, religious, spiritual, retirement interests and/or activities, as well as recovery from abuse and/or dependencies. The professional community 330 of FIG. 2B includes at least two members creating the community based upon a profession. Universities and the American Mathematical Society are both examples of professional communities. Businesses with offices in separate locations are another example of a professional community.

The fraternal community 332 of FIG. 2B includes members sharing a fraternal bond. The fraternities found on most college campuses in the U.S., as well as organizations such as the Elks and the Odd Fellows are all examples of fraternal communities. Some fraternal communities, such as the Boy Scouts and the Masonic Order are international in membership. The local community 334 of FIG. 2B includes members who reside or are interested in a geographic locale. The community members may be part time residents, regular vacation time residents, permanent residents, land holders, renters, or local service providers for those members and properties in the locale. Local communities also include schools, factories, shops, and most businesses situated in the locale.

A religious community 336 of FIG. 2B includes at least two members sharing the basic beliefs of a religion. Religion, as used herein, will refer to a collection of beliefs. Examples of religious communities include the Catholic, Mormon, Islam, Buddhism, and Judaism communities.

FIG. 2D shows the means 90 for serving the community 300, of FIG. 2B, including the web-service product 50 used 92 by at least one local computer system 98 operated 94 by at least one community member 302.

As used herein, the web-service products of the invention, used by a local computer system and/or a local server, are imperceptible to local area networks in their physical vicinity. Local area networks include, but are not limited to, any combination of wireless networks and wireline networks. Examples of a local computer system include, but are not limited to, computer systems without network interfaces. Local computer systems and local servers are fundamentally unable to transmit critical information such as the maiden name of someone's mother. Community members who are physically near such systems may access the web-service product(s).

Local computer systems and/or local servers often operate outside an office setting. These systems are preferably packaged to fit in an individual's, family's or community's living, recreational, entertainment, or meeting place(s). The packaging may support, but is not limited to, standalone units, wall mounted units, and/or units hung from a ceiling. These systems may have internal power sources and/or use external power.

FIG. 2E shows the means 90 for serving the community 300, of FIG. 2B, including web-site 148 hosting 92 the web-service product 50 accessible 94 only by the community members 302.

FIG. 2F shows the means 90 for serving the community 300, of FIG. 2B, including local means for 96 hosting 92 the web-service product 50 accessible 94 by the community members 302.

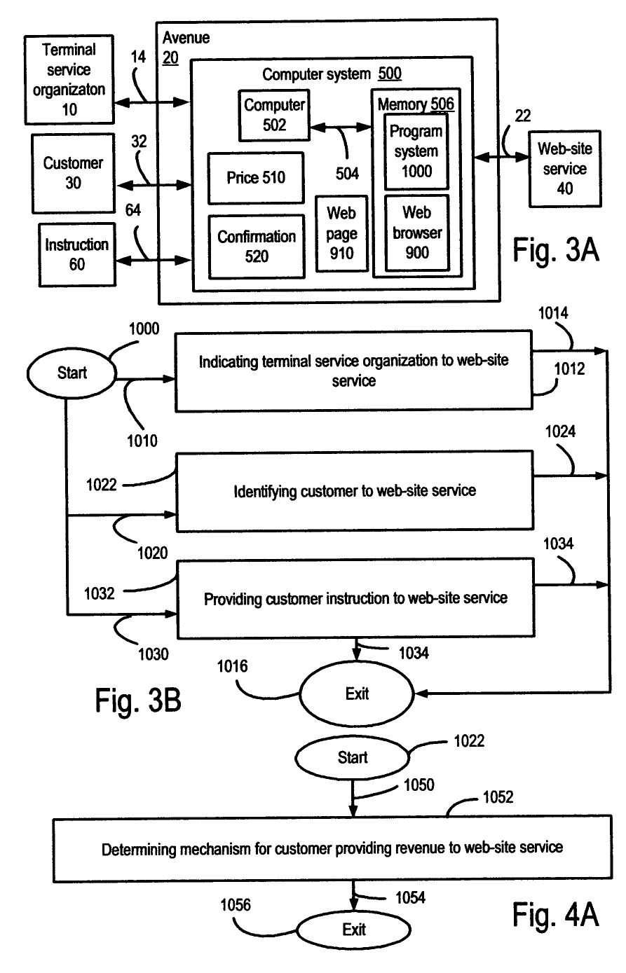

FIG. 3A shows the avenue 20 of FIG. 1A including a computer system 500.

The computer system 500 identifies 32 the customer 30 and identifies 14 the terminal service organization 10 to 22 the web-service 40, and provides 64 the customer instruction 50 to 22 the web-service 40.

The communications between the customer 30 and computer system 500 may include, but are not limited to,

interactions involving visual and audio displays presented to the customer, as well as,

customer hand based events and acoustic events recognized by the computer 502. The hand events include, but are not limited to, pointing device events, touch based events, and gesture events.

Communications 22 between the web-service 40 and computer system 500 may include, but are not limited to,

Client-server, Business-to-Business, and/or Peer-to-Peer network communications, where the communications path 22 may include wireline and/or wireless physical transport layers, and possibly multiple communication protocols.

The computer system 500 preferably, includes, but is not limited to,

A program system 1000 including at least one program step residing in a memory 506 accessibly coupled 504 to a computer 502.

A web browser 900 and a web page 910, typically residing in memory 506.

A price 510 for the instruction 60, and

The computer 502 receiving a confirmation 520 from the customer 30 to pay the web-service 40 providing 42 the web-service product 50 based upon the instructions 60 at price 510.

However, various embodiments of the invention may include either web browser 900 and/or web page 910 being distinct elements within the computer system 500.

Either the web browser and/or web page may be received 22 from the web-service 40.

Alternatively, the computer system 500 may include either web browser 900 and/or web page 910 embedded in the computer system on an essentially permanent basis.

The customer 30 preferably interacts with at least one web page 910 to implement the method of the invention using the avenue 20.

The interaction occurs through the operation of the computer 502 directed by 504 the program system 1000, the web browser 900, and the web page 910.

For the sake of simplicity, the discussion of the method of using computer system 500 as the avenue 20 will be in terms of program steps in program system 1000.

A computer as used herein will include, but is not limited to at least one instance of a member of the collection comprising an instruction processor, an inferential engine, a neural network, and a finite state machine. The instruction processor includes at least one instruction processing element and at least one data processing element, each data processing element controlled by at least one instruction processing element.

The following figures include flowcharts of at least one method of the invention possessing arrows with reference numbers. These arrows signify the flow of control and sometimes data. The arrows support implementations including at least one program step or program thread executing upon a computer, inferential links in an inferential engine, state transitions in a finite state machine, and learned responses within a neural network.

The step of starting a flowchart refers to at least one of the following.

Entering a subroutine in a macro instruction sequence in a computer.

Entering a deeper node of an inferential graph.

Directing a state transition in a finite state machine, possibly while pushing a return state.

Triggering at least one neuron in a neural network.

The step of termination in a flowchart refers to at least one of the following.

Return from a subroutine.

Traversal to a higher node in an inferential graph.

Popping of a previously stored state in a finite state machine.

Return to dormancy of the firing neurons of the neural network.

Alternatively, a source step of an arrow pointing to termination, may be the only step represented in the flowchart. Alternatively, one or more of the other steps may execute, either sequentially or concurrently, to implement the method of the invention.

A step in a flowchart refers to at least one of the following.

The instruction processor at least partly implements the step by responding to the program steps to control the data execution unit.

The inferential engine at least partly implements the step by responding to the program steps as nodes and transitions within an inferential graph based upon and modifying an inference database.

The neural network at least partly implements the step by responding to the program steps as stimulus.

The finite state machine at least partly implements the step by responding to the program steps through at least one of a state and a state transition.

The memory referred to herein includes at least one instance of at least one member of a memory type collection comprising: a non-volatile memory, and a volatile memory. A non-volatile memory includes at least one memory state retained without applying a power source to the non-volatile memory. The volatile memory includes at least one memory state lost without applying the power source to the volatile memory.

FIG. 3B shows a flowchart of the invention's method 1000 providing the avenue 20 of FIGS. 1A and 3A.

Step 1012 supports indicating 14 the terminal service organization 10 to 22 the web-service 40.

Step 1022 supports identifying the customer 30 to 22 the web-service 40.

Step 1032 supports providing the customer instruction 60 to the web-service 40.

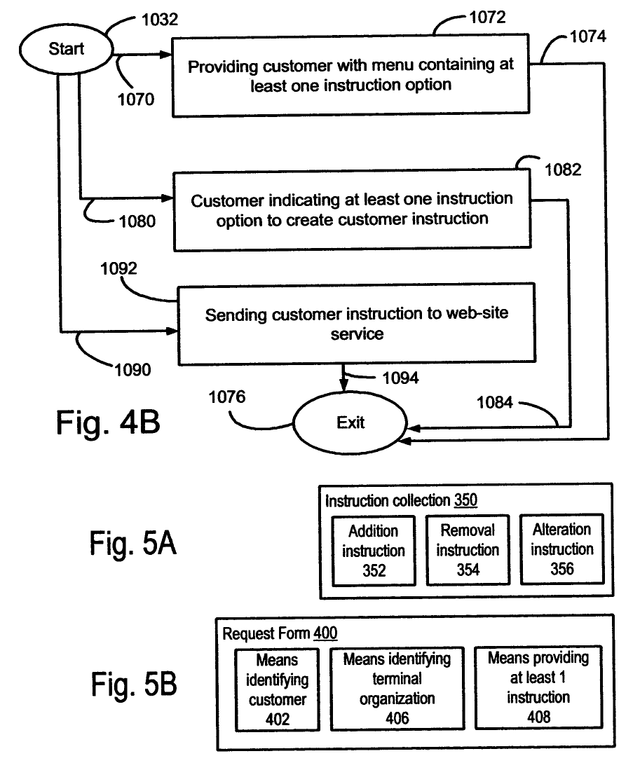

FIG. 4A shows a detail of step 1022 of FIG. 3B identifying the customer 30. Step 1052 supports the customer 30 determining the mechanism for providing 36 the revenue 70 to 72 the web-service 40 as shown in FIG. 1A.

FIG. 4B shows a detail of step 1032 of FIG. 3B creating and sending the customer instruction 60 of FIG. 1A and 3A.

Step 1072 supports providing the customer 30 with a menu containing at least one instruction option.

Step 1082 supports the customer 30 indicating at least one instruction option to create a customer instruction 60.

Step 1092 supports sending the customer instruction 60 to the web-service 40.

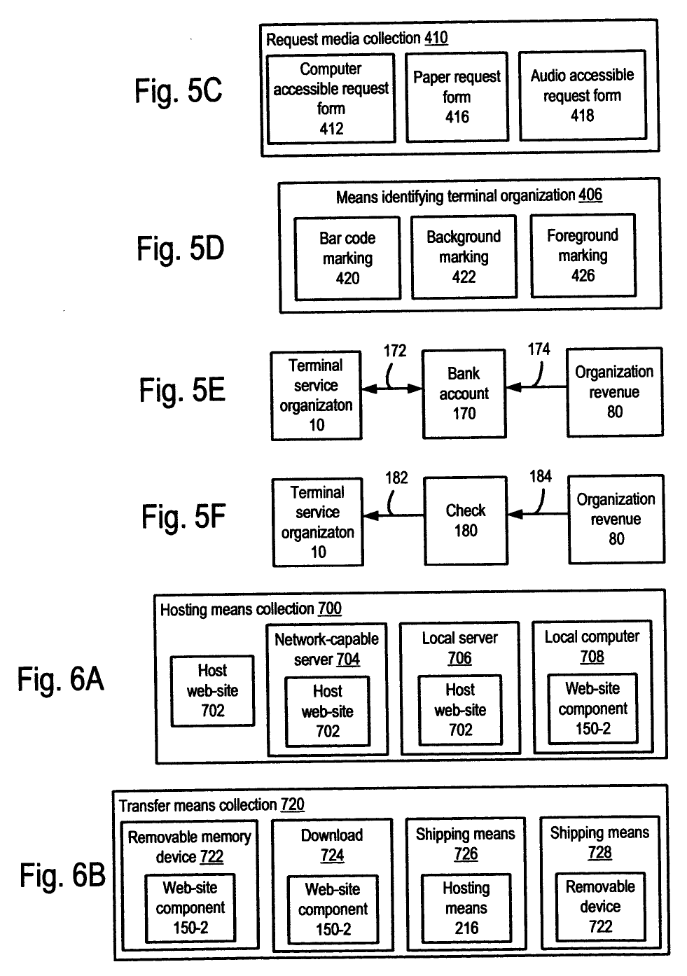

The instruction 60 of FIG. 1A includes at least one member of an instruction collection 350 shown in FIG. 5A for a web site component 150 of web-service product 50 of FIG. 1C. The instruction collection 350 includes, but is not limited to, the following:

Add 352 a web site component 150.

Remove 354 the web site component 150.

Alter 356 the web site component 150.

Aspects of the invention include the avenue 20 of FIG. 1A at least partly implemented as a request form 400, as shown in FIG. 5B. The request form 400 preferably further includes:

Means 402 for identifying the customer 30 to the web-service 40,

Means 406 for providing the instruction 60 to the web-service 40, and

Means 408 for identifying the terminal service organization 10 perceptible by at least the web-service 40.

The request form 400 is a member of the request media collection 410 comprising: a computer accessible request form 412, a paper request form 416, and an audio accessible request form 418, as shown in FIG. 5C.

FIG. 5D shows several preferred embodiments of means 408 identifying the terminal service organization 10 when the request form 400 is a paper request form 416. These include at least one of the following:

A bar code marking 420 identifying the terminal service organization 10,

A background marking 422 identifying the terminal service organization 10, and

A foreground marking 426 identifying the terminal service organization 10.

In certain embodiments of the invention, foreground markings 426 may be preferred. A terminal service organization may choose to be identified with a symbol such as a coat of arms, banner, insignia, logo and/or trademark, which is presented with essentially no overlay. A background marking 422 may include a watermark and/or border pattern.

Various combinations of markings shown in FIG. 5D may identify more than one terminal service organization 10 involved in enlisting the customer 30 of FIG. 1A.

By way of example, a foreground marking may identify a Catholic diocese.

A parish church within the diocese may be identified by any of a second foreground marking, a background marking or a bar code marking.

A hospice run by the parish church may be identified by any of a third foreground marking, a second background marking, or second bar code marking.

In this example, any combination of the diocese, parish church and hospice may receive the organization revenue 80 of FIG. 1A.

The means for the terminal service organization 10 receiving 84 the organization revenue 80 of FIG. 1A preferably includes at least one of the following in many aspects of the invention:

Means for a bank account 170 controlled 172 by the terminal service organization 10 receiving 174 a monetary transfer of the organization revenue 80 shown in FIG. 5E, and

Means for the terminal service organization 10 receiving 182 a check 180 for 184 the organization revenue 80 shown in FIG. 5F.

The organization revenue 80 of FIG. 1A, may be based upon multiple web-site revenues 70, which may further be based upon any combination of the following:

More than one customer 30, and/or

More than one avenue 20, and/or

More than one web-service product 50 provided by the web-service 40.

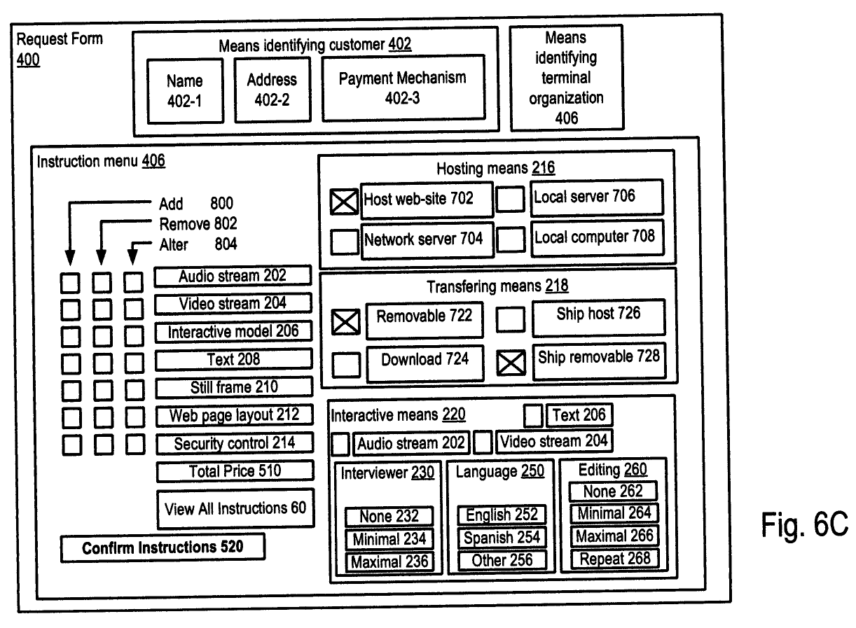

The hosting means 216 of FIG. 1D, may include any of the following members of the hosting means collection 700, in FIG. 6A:

a host web-site 702 providing at least the second web-site component 150-2,

a network capable server 704 hosting the host web-site 702,

a local server 706 hosting the host web-site 702, and/or

a local computer system 708 providing at least the second web-site component 150-2.

The transferring means 218 of FIG. 1D may include any of the transfer means collection 720 shown in FIG. 6B:

A removable memory device 722 provided by the web-service 40 containing at least the second web-site component 150-2 as in FIG. 1C. Removable memory devices 722 include, but are not limited to CD-ROMs, CD-RAMs, DVD ROM and RAMs, as well as removable disk drives in all form factors, including but not limited to, Compact Flash, and PCMCIA.

A download 724 provided by the web-service 40 containing at least the second web-site component 150-2. The download may be in the form of sending a communication such as an email, a live update, and/or require a web browser to initiate and/or perform.

A shipping means 726 for the hosting means 216 as in FIGS. 1D and 6A, and

a shipping means 728 for the removable device 722.

FIG. 6C shows a preferred request form 400 of FIG. 5B, including the following,

Means 402 for identifying the customer 30 to the web-service 40, further includes

A name field 402-1,

An address field 402-2, and

A way for the customer to determine the payment mechanism 402-3.

Instruction menu 406 providing the instruction 60, including the following:

Instruction commands add 800, remove 802, and alter 804 for one or more of the following:

an audio stream 202, a video stream 204, an interactive model 206, a text 208, a still frame 210, a web page layout 212, and a security control 214.

A total price 510 for the instruction 60.

When the request form 400 is a computer accessible request form 418, it preferably includes a View All Instructions 60 button or activator.

A means 520 for the customer 30 to confirm paying 36 the price 510 to create 36 the web-site revenue 70.

The web-site revenue 70 is, based at least partly upon the web-service 40 providing the web-service products 50 customized by the instructions 60.

A hosting means menu 216, preferably supporting the customer 30 selecting one or more of the following:

a host web-site 702 providing at least the second web-site component 150-2,

a network capable server 704 hosting the host web-site 702,

a local server 706 hosting the host web-site 702, and/or

a local computer system 708 providing at least the second web-site component 150-2.

A transferring means menu 218 preferably supporting the customer 30 selecting one or more of the following:

a removable memory device 722 provided by the web-service 40 containing at least the second web-site component 150-2 as in FIG. 1C,

a download 724 provided by the web-service 40 containing at least the second web-site component 150-2,

a shipping means 726 for the hosting means 216 as in FIGS. 1D and 6A, and

a shipping means 728 for the removable device 722.

An interactive means menu 220, which preferably includes the following:

a stream generation component including at least generating an audio stream 202 and/or generating a video stream 204,

an interviewer component 230, including support for the customer 30 selecting none 232, minimal 234, or maximal 236 interviewer support,

preferably, the menu 220 includes a language component 250, including a first language 252, for example, English, a second language 254, Spanish, and another language 256 in which the interviewer interacts, and

an editor component 260, including none 262, minimal editing 264, maximal editing 266, and repeated editing 268.

Means 408 for identifying the terminal service organization 10.

In certain aspects of the invention, the stream generation may further include an option to generate a text as a product of the interactive means process performed by the web-service 40.

When the request form 400 of FIG. 6C is a paper request form 416, the means 520 for the customer 30 to confirm paying 36 the price 510 to create 36 the web-site revenue 70 may include a signature area. When the request form 400 is a computer accessible request form 412, it may include a button for the customer 30 to activate. For example, activation may entail the customer 30 pushing the button, or pointing at the button and clicking a mouse. Alternatively, activation may involve the customer 30 making sounds.

The request form 400 of FIG. 6C, is a sketch of preferred avenues 20 by which a customer 30 may instruct 60 a web-service 40 provide 42 web-service products 50. The avenue 20 identifies 406 the terminal service organization 10, which enlisted 12 the customer 30. The avenue 20 also identifies 402 the customer 30, further providing a means 402-3 for determining the payment mechanism.

The details of instructing the web-service 40, for adding 800, removing 802, or altering 804 web-site components 202 to 214 will vary depending upon the request media collection 410 member embodied.

When the request form 400 is a computer accessible request form 412, adding 800, removing 802, or altering 804 web-site components 202 to 214 may trigger hyperlinks to dialogues for the customer providing the specifics of the instruction. These may include selection of files containing audio streams, video streams, still frames, and so on. In certain embodiments of the invention, inserting still frames into a scanner may be part of building the instructions.

When the request form 400 is a paper request form 416, the generation of instructions will vary. Attachments for still frames on computer-readable media or on paper are preferred. Attachments for video and audio streams on computer-readable media, various forms of magnetic tape devices, and possibly phonographic recordings may be preferred.

When the request form 400 is an audio accessible request form 418, the receipt of the attachments will preferably be arranged as a delivery 62 to the web-service 40 to complete the instructions 60.

The preceding embodiments provide examples of the invention and are not meant to constrain the scope of the following claims.

What is claimed is:

1. A mechanism for a terminal service organization enlisting a customer for a web-service, comprising:
means for providing an avenue by which said terminal service organization can refer said customer to said web-service; wherein said avenue identifies said terminal service organization to said web-service;
means for said customer using said avenue to engage said web-service to provide at least one web-service product customized by at least one instruction from said customer, to create a web-site revenue for said web-service; and
means for said terminal service organization receiving an organization revenue based upon said customer using said avenue to create said web-site revenue;
wherein said terminal service organization includes at least one member of the collection comprising: a funeral home, a retirement community, a hospice, a hospital, a sanitarium, a temple, a synagogue, a mosque, a church, a shrine, a nursing home, a mausoleum, a cemetery, and an assisted living facility;
wherein said web-service product includes at least one web-site component, which is an instance of a member of the web-site component collection;
wherein said web site component collection comprises an audio stream, a video stream, an interactive model, a text, a still frame, a web page layout, a security control, a hosting means for at least a second of said web-site components, a transferring means for at least one of said second web-site components, and an interactive means for generating at least one of said second web-site components.

2. The mechanism of claim 1, wherein said web-site component collection further includes at least one member of the web system collection comprising: a memorial web page system, a personal web page system, a family web page system, and a community web page system.

3. The mechanism of claim 1, wherein said instruction includes at least one member of an instruction collection about at least one of said web site components.

4. The mechanism of claim 3, wherein said instruction collection includes an addition instruction for said web-site component, a removal instruction for said web-site component, an alteration instruction for said web-site component.

5. The mechanism of claim 1, further comprising at least one member of the collection comprising:
said web-service product provided to a means for serving a community;
said hosting means is locally accessible by at least one member of said community;
wherein said community includes at least one instance of at least one member of the community type collection comprising: a nuclear family, an extended family, a distributed family, an intentional community, a professional community, a fraternal community, a local community, and a religious community.

6. The mechanism of claim 5, wherein the means for serving said community is comprised of at least one member of the collection comprising:
said web-service product used by at least one local computer system operated by at least one member of said community;
a web-site hosting said web-service product accessible only by said community members; and
a local means for hosting said web-service product accessible by said community members.

7. The mechanism of claim 1, wherein said hosting means is comprised of at least one member of the hosting means collection comprising:
a host web-site providing at least said second web-service component;
a network capable server hosting said host web-site;
a local server hosting said host web-site; and
a local computer system providing at least said second web-service component;
wherein each of said local server and said local computer system are imperceptible to local area networks in the vicinity of said housing means.

8. The mechanism of claim 1, wherein said transferring means is comprised of at least one member of the transfer means collection comprising:
a removable memory device provided by said web-service containing at least said second web-site component;
a download provided by said web-service containing at least said second web-site component; and
a shipping means for said hosting means; and
shipping said removable memory device.

9. The mechanism of claim 1, wherein said avenue includes a computer system identifying said customer and identifying said terminal service organization, to said web-service, to provide said customer instruction to said web-service.

10. The mechanism of claim 9, wherein said computer system is further comprised of a program system including at least one program step residing in a memory accessibly coupled to a computer, at least partially implementing the steps comprising:
indicating said terminal service organization to said web-service;
identifying said customer to said web-service; and
providing said customer instruction to said web-service.

11. The mechanism of claim 10, wherein the program step identifying said customer is further comprised of the program step said customer determining the mechanism for providing said revenue to said web-service.

12. The mechanism of claim 10, wherein the program step providing said customer instruction is further comprised of the program steps of:
providing said customer with a menu containing at least one instruction option;
said customer indicating at least one instruction option to create a customer instruction; and
sending said customer instruction to said web-service.

13. The mechanism of claim 1, wherein said avenue at least partially implemented as a request form further comprising:
means for identifying said customer to said web-service;
means for providing said instruction to said web-service; and
means for identifying said terminal service organization perceptible by at least said web-service.

14. The mechanism of claim 13, wherein said request form is a member of the request media collection comprising: a computer accessible request form, a paper request form, and an audio accessible request form.

15. The mechanism of claim 14, wherein the means for identifying said terminal service organization in said paper request form includes at least one member of the collection comprising:
a bar code marking identifying said terminal service organization;
a background marking identifying said terminal service organization; and
a foreground marking identifying said terminal service organization.

16. The mechanism of claim 1, wherein the means for said terminal service organization receiving said organization revenue includes at least one member of the revenue reception collection comprising:
means for a bank account controlled by said terminal service organization receiving a monetary transfer of said organization revenue; and
means for said terminal service organization receiving a check for said organization revenue.

17. The mechanism of claim 1, wherein the interactive means comprises a stream generation component, an interviewer component and an editor component;
wherein said stream generation component include generating at least one member of the collection comprising said text, said audio stream and said video stream;
wherein said interview component includes a member of an interviewer option collection, comprising a no-interviewer option, a minimal interviewer option, a maximal interviewer option;
wherein said interview component further includes an interview language selection;
wherein said editor component includes a member of the editing collection comprising a no-editing option, a minimal editing option, a more editing option, and a maximal editing option.

18. A method for a terminal service organization enlisting a customer for a web-service, comprising the steps of:
providing an avenue by which said terminal service organization can refer said customer to said web-service;
said avenue identifying said terminal service organization to said web-service;
said customer using said avenue to engage said web-service to provide at least one web-service product customized by at least one instruction from said customer, to create a web-site revenue for said web-service; and
said terminal service organization receiving an organization revenue based upon said customer using said avenue to create said web-site revenue.

19. The method of claim 18, wherein said terminal service organization includes at least one member of the collection comprising: a funeral home, a retirement community, a hospice, a hospital, a sanitarium, a temple, a synagogue, a mosque, a church, a shrine, a nursing home, a mausoleum, a cemetery, and an assisted living facility.

20. The method of claim 18, wherein said web-service product includes at least one web-site component, which is an instance of a member of the web-site component collection; and
wherein said web site component collection comprises an audio stream, a video stream, an interactive model, a text, a still frame, a web page layout, a security control, a hosting means for at least a second of said web-site components, a transferring means for at least one of said second web-site components, and an interactive means for generating at least one of said second web-site components.

21. The method of claim 18, wherein said web-site component collection further includes at least one member of the web system collection comprising: a memorial web page system, a personal web page system, a family web page system, and a community web page system.

22. The method of claim 18, wherein said instruction includes at least one member of an instruction collection about at least one of said web site components.

23. The method of claim 22, wherein said instruction collection includes an addition instruction for said web-site component, a removal instruction for said web-site component, an alteration instruction for said web-site component.

24. The method of claim 18, further comprising at least one member of the collection comprising the steps of:
providing said web-service product to a means for serving a community; and
at least one member of said community locally accessing said hosting means;
wherein said community includes at least one instance of at least one member of the community type collection comprising: a nuclear family, an extended family, a distributed family, an intentional community, a professional community, a fraternal community, a local community, and a religious community.

25. The method of claim 24, wherein the step of serving said community is comprised of at least one member of the collection comprising the steps of:
at least one local computer system operated by at least one member of said community using said web-service product;
a web-site hosting said web-service product accessible only by said community members; and
hosting said web-service product locally accessible by said community members.

26. The method of claim 18, wherein said hosting means is comprised of at least one member of the hosting means collection comprising:
a host web-site providing at least said second web-service component;
a network capable server hosting said host web-site;
a local server hosting said host web-site; and
a local computer system providing at least said second web-service component;
wherein each of said local server and said local computer system are imperceptible to local area networks in the vicinity of said housing means.

27. The method of claim 18, wherein implementing said transferring means is comprised of at least one member of the transfer means collection comprising the steps of:
providing a removable memory device containing at least said second web-site component;
providing a download containing at least said second web-site component;
shipping said hosting means; and
shipping said removable memory device.

28. The method of claim 18, wherein said avenue includes a computer system identifying said customer and identifying said terminal service organization, to said web-service, to provide said customer instruction to said web-service.

29. The method of claim 28, wherein said computer system is further comprised of a program system including at least one program step residing in a memory accessibly coupled to a computer, at least partially implementing the steps comprising:
indicating said terminal service organization to said web-service;
identifying said customer to said web-service; and
providing said customer instruction to said web-service.

30. The method of claim 29, wherein the step identifying said customer is further comprised of the step of said customer determining the mechanism for providing said revenue to said web-service.

31. The method of claim 29, wherein the step providing said customer instruction is further comprised of the steps of:
providing said customer with a menu containing at least one instruction option;
said customer indicating at least one instruction option to create a customer instruction; and
sending said customer instruction to said web-service.

32. The method of claim 18, wherein said avenue at least partially implemented as a request form further comprising:
identifying said customer to said web-service;
providing said instruction to said web-service; and
identifying said terminal service organization perceptible by at least said web-service.

33. The method of claim 32, wherein said request form is a member of the request media collection comprising: a computer accessible request form, a paper request form, and an audio accessible request form.

34. The method of claim 33, wherein the step identifying said terminal service organization in said paper request form includes at least one member of the collection comprising the steps of:
a bar code marking identifying said terminal service organization;
a background marking identifying said terminal service organization; and
a foreground marking identifying said terminal service organization.

35. The method of claim 18, wherein the step of said terminal service organization receiving said organization revenue includes at least one member of the revenue reception collection comprising:
receiving a monetary transfer of said organization revenue into a bank account controlled by said terminal service organization; and
receiving a check for said organization revenue by said terminal service organization.

36. The method of claim 18, wherein the interactive means comprises a stream generation component, an interviewer component and an editor component;
wherein said stream generation component include generating at least one member of the stream collection comprising said audio stream and said video stream;
wherein said interview component includes a member of an interviewer option collection, comprising a no-interviewer option, a minimal interviewer option, and a maximal interviewer option;
wherein said editor component includes a member of the editing collection comprising a no-editing option, a minimal editing option, a more editing option, and a maximal editing option.

37. The method of claim 36, wherein said stream collection further includes said text.

38. The method of claim 36, wherein said interview component further includes an interview language selection.

39. Said avenue provided to said customer, said customer instructions, said web-service products, said web-site revenue, and said organization revenue as products of the process of claim 18.
